(19) United States
(12) Patent Application Publication
(10) Pub. No.: US 2026/0144686 A1
(43) Pub. Date: May 28, 2026

(54) Automated Wheelchair Follow Module for Patient Safety and Mobility Assistance

(71) Applicants: Mohammed Abdallah, New Hartford, NY (US); Ashraf Elmarakby, Clinton, NY (US); Yusuf Elazzazi, New Hartford, NY (US); Ahmed Radwan, New Hartford, NY (US)

(72) Inventors: Mohammed Abdallah, New Hartford, NY (US); Ashraf Elmarakby, Clinton, NY (US); Yusuf Elazzazi, New Hartford, NY (US); Ahmed Radwan, New Hartford, NY (US)

(21) Appl. No.: 18/957,591

(22) Filed: Nov. 22, 2024

(51) Int. Cl. A61G 5/04

(52) U.S. Cl. CPC A61G 5/04; A61G 2203/10; A61G 2203/70

(57) ABSTRACT

The present invention provides a modular system to integrate with existing motorized wheelchairs, allowing the wheelchair to autonomously track and follow a patient during physical therapy sessions and other mobility-related activities. This reduces the need for manual assistance, allowing the wheelchair to follow the patient without additional staff involvement. The invention comprises an add-on containing two adjustable arms that attach to the wheelchair's existing joystick or control stick and is equipped with a camera and software that autonomously tracks the patient's movements. The wheelchair's motion (forward, backward, left, right) is controlled by the module, based on real-time visual feedback from the camera targeting the patient.

### BACKGROUND OF THE INVENTION

Physical therapy (PT) and rehabilitation for patients recovering from injury or surgery, or for elderly patients requiring assistance with mobility, present unique challenges in ensuring the safety and independence of the patient during treatment.

In acute care rehabilitation settings, physical therapists need to contact guard (grasp) these debilitated patients during gait training while the physical therapy assistant (PTA) or aide follow the patient with the wheelchair to have the patient sit when needed. Unavailability of PTAs due to treating/helping other patients or due to workforce shortage, can hamper this portion of the physical therapy session.

Same issue presents with the ambulatory wheelchair users/patients at nursing homes, these patients may have intense fatigue, unsteady balance, lower body injuries. chronic pain, or unstable joints. These patients can walk for limited amounts of time before needing to sit down which can range from one hour to few minutes and to do so, they need a helper to follow them with the wheelchair. Also, housebound patients and elderly people with any of the above conditions and live alone can walk using walking aids but need a helper to follow with the wheelchair. Unavailability of a family member at home or a helper especially in rural and remote areas where chronic shortages of health human resources 1,2 may impact this patient's walking independence and quality of life.

While powered wheelchairs provide mobility for patients with limited or no ability to walk, they do not actively provide safety assistance in preventing falls or actively following a patient during physical therapy treatments. There is currently no wheelchair system that allows for the automatic tracking of a patient and responds accordingly to prevent falls or assist in following the patient during PT sessions.

What is needed is a system that can safely monitor and follow a patient without requiring direct manual control by a physical therapy assistant, nurse, or an aid which could potentially reduce the need for additional staff, improve patient safety, and enhance the patient's mobility experience.

Availability of an automated wheelchair that can closely follow the patient while walking will provide an excellent solution for the previously mentioned functional problems.

Locations where the automated wheelchair can be used:
a. Health care facilities such as: Physical therapy rehabilitation centers, nursing homes, and inpatient rehabilitation units, acute care units, hospitals.
b. Patients Homes indoors/ outdoors).

### SUMMARY OF THE INVENTION

The present invention provides an automated, modular system configured for integration with existing wheelchairs, facilitating the wheelchair to autonomously track and follow a patient during physical therapy sessions or other mobility-related activities. The invention comprises a modular add-on that attaches to the wheelchair's existing joystick or control stick, equipped with a camera and software that autonomously tracks the patient's movements. The wheelchair's motion (forward, backward, left, right) is controlled by the module, based on real-time visual feedback from the camera targeting the patient.

The primary advantage of this invention is its ability to reduce the need for manual assistance, allowing the wheelchair to follow the patient without additional staff involvement, improving patient safety, and reducing staff workload. Furthermore, the invention is designed to be minimally invasive, enabling it to be retrofitted to virtually any existing wheelchair with minimal modification.

### BRIEF DESCRIPTION OF DRAWINGS

FIG. 1 illustrates a block diagram of the control system with corresponding inputs and outputs, wherein inputs are directed into the control system.

FIG. 2 provides a flowchart depicting the algorithm for determining wheelchair behavior, wherein said algorithm is implemented within the control system.

FIG. 3 depicts a model of the motor interface, wherein an adjustable socket is configured to fit over the existing joystick of the wheelchair. Each axis of movement is actuated by a respective motor.

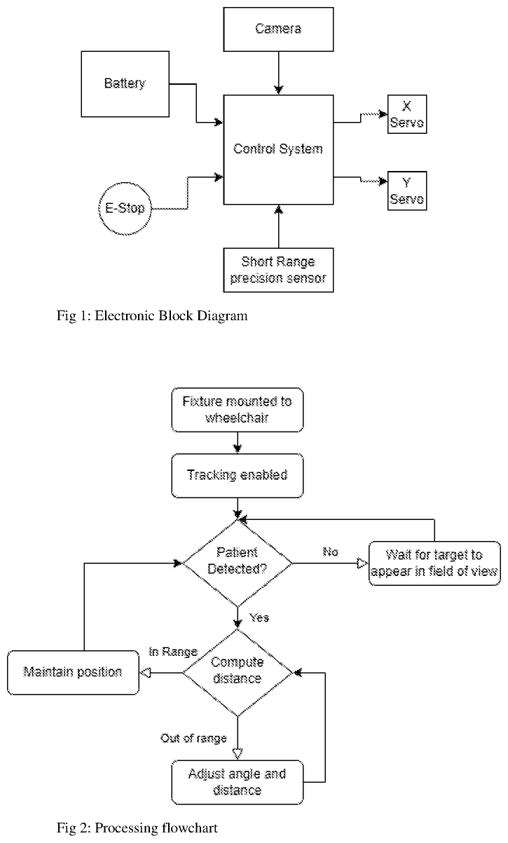

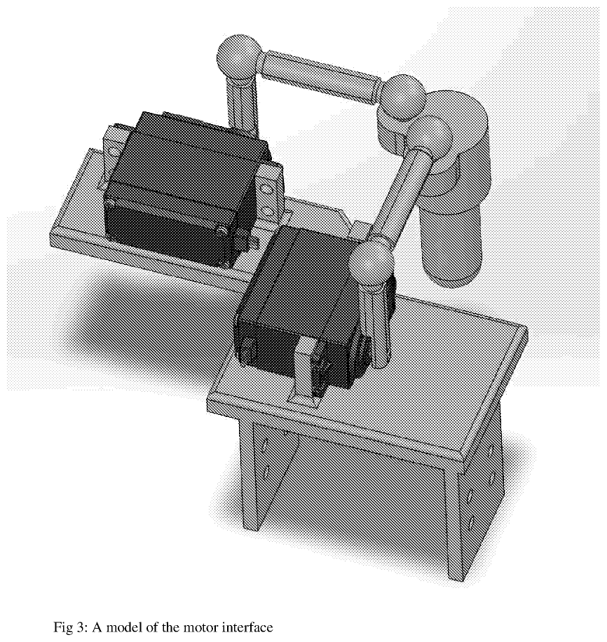

### DETAILED DESCRIPTION OF THE INVENTION

### 1. Modular System Overview

The proposed system consists of the following components:
1. Camera Module: A small, lightweight camera attached to the control stick or joystick of the wheelchair. The camera continuously tracks the position of the patient, using computer vision algorithms to maintain a real-time position fix.
2. Control System: A microcontroller or embedded computer that processes the data from the camera, interprets the movements of the patient, and sends corresponding control signals to the wheelchair's motors to move the wheelchair autonomously.
3. Motor Interface: An interface that connects the control system to the wheelchair's motor controllers, allowing for forward, backward, left, and right movement of the wheelchair based on commands from the system.
4. Battery and Power Management: A power supply unit to support the camera, control system, and motor interface, designed to be efficient and provide long operational periods.
5. User Interface (Optional): A control panel or mobile app interface allowing for manual override or adjustment of the system, providing an option for the therapist to intervene or modify the behavior of the system during a session.

### 2. How the System Works

The camera continuously monitors the patient, tracking their position relative to the wheelchair. When the patient moves, the system adjusts the wheelchair's movements accordingly:
Follow Mode: When the camera identifies the patient moving in a direction (e.g., walking forward, sideways, or turning), the system will move the wheelchair to match the patient's position, ensuring that it follows at a safe distance.
Safety Mode: If the system detects a sudden loss of balance or a fall event, the wheelchair will autonomously adjust its position to move closer to the patient, potentially reducing the impact of the fall by providing stability.
Directional Control: The system can adjust the wheelchair's speed and direction based on the patient's movements, ensuring smooth and natural following behavior.

### 3. Retrofitting Existing Wheelchairs

The key advantage of this invention is its retrofittable nature. The module is designed to be easily added to existing powered wheelchairs with minimal disruption. The process involves attaching the unit to the wheelchair armrest and positioning the motor interface to interact with the wheelchair's existing control unit. This allows for widespread adoption of the technology without requiring the patient to purchase a new wheelchair.

### Advantages of the Invention

1. Reduced Staffing Needs: By automating the process of tracking and following the patient, the invention reduces the need for additional staff (nurses or caregivers) to be present in close proximity to the patient during physical therapy. This allows healthcare facilities to optimize their staff deployment.
2. Enhanced Patient Safety: The system actively monitors the patient and ensures that the wheelchair is always positioned to prevent falls, automatically adjusting its position in response to changes in the patient's movements. This is particularly useful in physical therapy sessions where falls are a concern.
3. Cost Savings: Hospitals, rehabilitation centers, and nursing homes will save on staffing costs, as fewer personnel are required to be physically present for every patient session. Additionally, this technology can reduce injury risks for both patients and staff, leading to fewer liability claims.
4. Improved Patient Independence: For patients with limited mobility, this invention enables them to engage in more independent movement, providing the security of an automated system that follows and supports them during therapy without requiring constant human assistance.
5. Versatility in Applications: The invention is not only beneficial in rehabilitation settings, but can also be used in elderly care homes, home healthcare, and public spaces where people with mobility impairments are at risk of falls. For example, it could be used to track elderly patients and prevent falls in care homes, hospitals, or even at home.
6. Minimal Invasive Modifications: The modular design ensures that the system can be added to virtually any wheelchair with minimal modification or structural changes, making it accessible to a wide variety of patients and care facilities without needing to invest in entirely new equipment.

### Potential Use Cases

Physical Therapy and Rehabilitation: Therapists can focus on treatment while the system ensures the patient is safely tracked and followed during exercises, reducing the need for additional staff or the risk of falls.
Elderly Care: The system can be used in nursing homes or home care settings to automatically follow and support elderly individuals with mobility challenges, reducing the need for family members or caregivers to be constantly present.
Hospital and Care Facility Settings: Staff can use the system to monitor and assist patients who are at risk of falls or have limited mobility, improving safety and reducing staffing requirements.
Public Spaces and Shopping Centers: Wheelchair users in public spaces such as airports or malls can use the system to autonomously move through crowded areas while being safely followed by the wheelchair, reducing the need for assistance.

1. A modular system for retrofitting existing wheelchairs to enable automatic tracking and following of a patient, comprising:
a. A camera module for capturing the position of a patient;
b. A control system configured to receive data from the camera module and control the wheelchair's movement;
c. A processing algorithm for computing patient position in relation to the wheelchair;
d. A motor interface for connecting the control system to the wheelchair's user control, enabling movement in response to the patient's movements;
e. A power supply unit for providing power to the system.

2. The modular system of claim 1, wherein the control system is configured to control the wheelchair's movement in at least four directions: forward, backward, left, and right.

3. The modular system of claim 1, wherein the camera module uses computer vision algorithms to track the patient's position and adjust the wheelchair's movement accordingly.

4. The modular system of claim 1, wherein the system includes a safety mode that automatically adjusts the wheelchair's position if the system detects a fall or a loss of balance by the patient.

5. The modular system of claim 1, wherein the system can be retrofitted to a variety of wheelchair models with minimal modifications.

6. A method for assisting a patient with physical therapy using the modular system of claim 1, wherein the wheelchair autonomously follows the patient during therapy sessions to improve patient safety and reduce staffing requirements.
